(19) United States
(12) Patent Application Publication
(10) Pub. No.: US 2008/0122380 A1
(43) Pub. Date: May 29, 2008

(54) Discharge Lamp Lighting Circuit

(75) Inventors: Kotaro Matsui, Shizuoka (JP); Tomoyuki Ichikawa, Shizuoka (JP); Takuya Serita, Shizuoka (JP)

Correspondence Address: FISH & RICHARDSON P.C., P.O. BOX 1022, MINNEAPOLIS, MN, 55440-1022, US

(73) Assignee: KOITO MANUFACTURING CO., LTD., Tokyo (JP)

(21) Appl. No.: 11/767,822

(22) Filed: Jun. 25, 2007

(30) Foreign Application Priority Data
Jun. 26, 2006 (JP) 2006-175561

(51) Int. Cl. H05B 41/24

(52) U.S. Cl. 315/276

(57) ABSTRACT

A discharge lamp lighting circuit supplies an AC power for lighting a discharge lamp. The discharge lamp lighting circuit includes a power supply portion for supplying the AC power to the discharge lamp and a control portion for controlling the magnitude of the AC power. The power supply portion includes a series resonance circuit including transistors, a transformer, a capacitor and an inductor and a bridge driver for driving the transistors. The control portion controls the bridge driver so that the AC power increases intermittently. Thus, as the temperature of electrodes can be increased while suppressing the temporal average value of the supplied power within a rated power, the movement of a luminous point at the time of lighting the discharge lamp with a high frequency can be suppressed.

The present application claims the benefit of priority of Japanese Patent Application No. 2006-175561 filed on Jun. 26, 2006. The disclosure of that application is incorporated herein by reference.

### TECHNICAL FIELD

The present disclosure relates to a discharge lamp lighting circuit.

### BACKGROUND TECHNIQUE

A lighting circuit (ballast) for supplying an electric power in a stable manner is required in order to light a discharge lamp such as a metal halide lamp used for a head lamp for a vehicle For example, a discharge lamp lighting circuit disclosed in a Japanese Patent Document JP-A-2005-63823 includes a DC-AC conversion circuit having a series resonance circuit, whereby an AC power is supplied to the discharge lamp from the DC-AC conversion circuit.

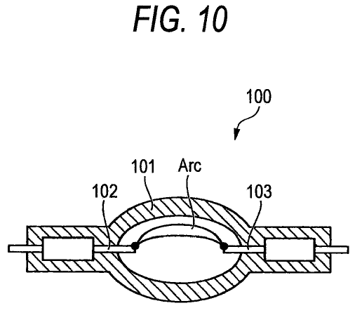

FIG. 10 is a sectional diagram schematically showing a state within the tube of a discharge lamp being lighted. A discharge lamp 100 is configured in a manner that two electrodes 102 and 103 are disposed in an opposite manner within a glass tube 101 in which metallic halide such as Na is filled. When a high-voltage pulse is applied between the electrodes 102 and 103, a discharge arc (“Arc”) is generated between the electrodes 102 and 103 thereby to conduct therebetween. Thereafter, a discharge lamp lighting circuit controls the magnitude of the AC power so that the discharge arc (Arc) is maintained in a stable manner while supplying the AC power between the electrodes 102 and 103. The metallic halide is excited by the discharge arc (Arc) within the glass tube 101, so that a high-intensity illumination can be obtained.

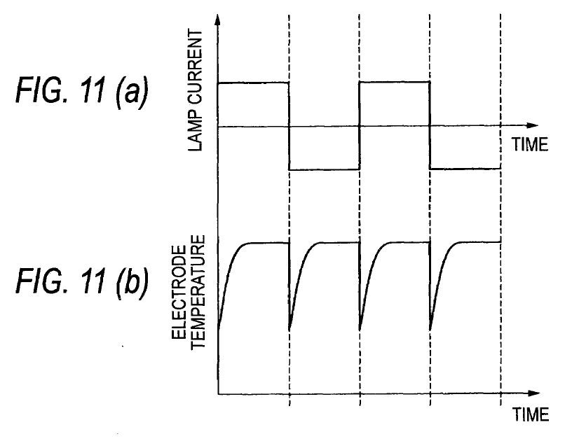

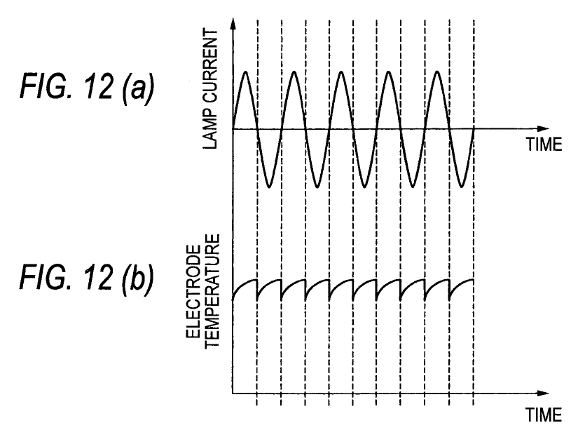

A discharge lamp lighting circuit generally used at present supplies a lamp current formed by a rectangular waveform of a relatively low frequency (for example, several hundreds Hz) to a discharge lamp. However, due to the miniaturization of a discharge lamp lighting circuit, sometimes it is desirable to set the frequency of an AC power to a high frequency of 1 MHz or more, for example. FIG. 11 illustrates a graph showing an example of a lamp current waveform in a case where a lamp current formed by a rectangular waveform of a relatively low frequency is supplied to a discharge lamp 100 (FIG. 11(a)) and a graph showing an example of a temperature change of electrodes 102, 103 corresponding thereto (FIG. 11(b)). FIG. 12 illustrates a graph showing an example of a lamp current waveform in a case where an AC current of a relatively high frequency is supplied to a discharge lamp 100 (FIG. 12(a)) and a graph showing an example of a temperature change of the electrodes 102, 103 corresponding thereto (FIG. 12(b)).

As shown in FIG. 11(a) and (b), in the case where the lamp current of the relatively low frequency is supplied to the discharge lamp 100, the electrodes 102, 103 are heated sufficiently by the lamp current and so the electrode temperature becomes sufficiently high when the polarity is switched. However, as shown in FIG. 12(a) and (b), in the case where the AC current of the relatively high frequency is supplied to the discharge lamp 100, since a heating time of the electrodes 102, 103 at each period is short, the temperatures of the electrodes 102, 103 are not sufficiently increased when the polarity is switched. Thus, electron emission property (efficiency ) of the electrodes 102, 103 at the time of the polarity switching is degraded.

The luminance distribution of a discharge arc (Arc) is high in a luminance at the electron emission points. When the electron emission property of the electrodes 102, 103 degrades, of many fine projections existing on the surface of the electrode, the projection from which electrons are most likely emitted changes with a time lapse, whereby a point where a luminous point as the electron emission point is generated moves. Thus, the position of the luminous point is not stable and so the luminance distribution of the discharge arc (Arc) becomes unstable.

### SUMMARY

The invention is made in view of the foregoing problem, and, among other things, provides a discharge lamp lighting circuit which can suppress the movement of a luminous point at a time of lighting the discharge lamp with a high frequency.

According to one aspect, a discharge lamp lighting circuit is arranged in a manner that the discharge lamp lighting circuit which supplies an AC power for lighting a discharge lamp to the discharge lamp, includes: a power supply portion which supplies the AC power to the discharge lamp; and a control portion which controls a magnitude of the AC power, wherein the power supply portion includes a series resonance circuit having a plurality of switching elements, at least one of an inductance and a transformer and a capacitor, and a driving portion which drives the plurality of switching elements, and the control portion controls the driving portion so that the AC power increases intermittently.

As described above, the movement of a luminous point at the time of lighting the discharge lamp with a high frequency is caused by the insufficient increase of the electrode temperature when the polarity is switched. Although the electrode temperature can be increased by increasing the supplied power, since the rated power of the discharge lamp is generally determined to a certain value (in a range between 35±2 W in the case of the HID for an automobile), the life time of the discharge lamp is influenced when an excessive power is supplied constantly. In contrast, in the foregoing discharge lamp lighting circuit, since the control portion controls the driving portion so that the AC power supplied to the discharge lamp increases intermittently, the temperature of the electrodes can be increased while suppressing the temporal average value of the supplied power to a value near the rated power. Thus, according to the foregoing discharge lamp lighting circuit, the movement of a luminous point at the time of lighting the discharge lamp with a high frequency can be effectively suppressed.

Various implementations include one or more of the features discussed in the following paragraphs. For example, the discharge lamp lighting circuit may be arranged in a manner that the control portion controls the driving portion so that the AC power increases in an impulse manner. Thus, the electrode temperature can be increased intermittently while more suitably suppressing the temporal average value of the supplied power. In this case, the waveform of the AC power increasing in the impulse manner represents a waveform of the AC power which has an extreme value larger than the an average power value and in which the magnitude of the AC power increases in a time period just before the extreme value and decreases in a time period just after the extreme value, and the time width of the waveform is set arbitrarily.

Further, the discharge lamp lighting circuit may be arranged in a manner that the control portion controls the driving portion so that a magnitude of the AC power becomes a first power value in a first time region repeated periodically and becomes a second power value larger than the first power value in a second time region other than the first time region. Thus, since the electrode temperature is increased sufficiently in the second time region and the lighting state is kept in the first time region by the so-called after growing, the movement of a luminous point can be suppressed more effectively.

Further, the discharge lamp lighting circuit may be arranged in a manner that the control portion controls the driving portion so that a frequency of the AC power increases and decreases continuously and repeatedly and the AC power increases intermittently from a timing where the AC power becomes a minimum. Thus, the movement of a luminous point can be suppressed while also suppressing the acoustic resonance.

Further, the discharge lamp lighting circuit may be arranged in a manner that the control portion starts to intermittently increase the AC power upon lapse of a predetermined time after start of lighting of the discharge lamp. Since the arc discharge is unstable immediately after the lighting of the discharge lamp, in most cases, the starting performance of the discharge lamp is secured by supplying to the discharge lamp the maximum power within the power supply ability of the discharge lamp lighting circuit. In this case, when the supplied power is changed intermittently, there arises a case that the discharge lamp is turned off since there appears a time period during which the supplied power becomes smaller than the maximum power. In contrast, like the discharge lamp lighting circuit, when the intermittent increase of the supplied power is started upon the lapse of the predetermined time after the start of the lighting of the discharge lamp, not only the starting performance of the discharge lamp can be secured but also the movement of luminous point can be suppressed, preferably.

In some implementations, the movement of a luminous point at the time of lighting the discharge lamp with a high frequency can be suppressed.

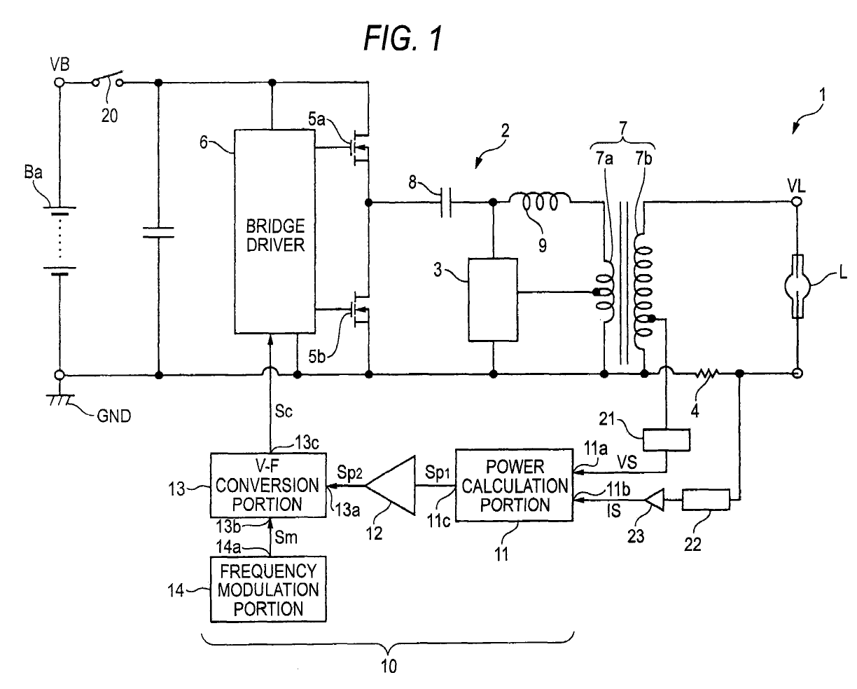

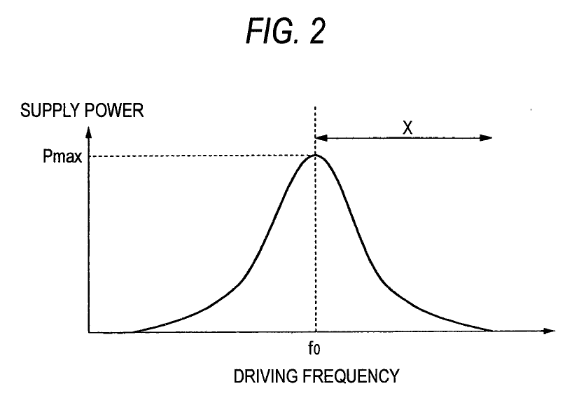

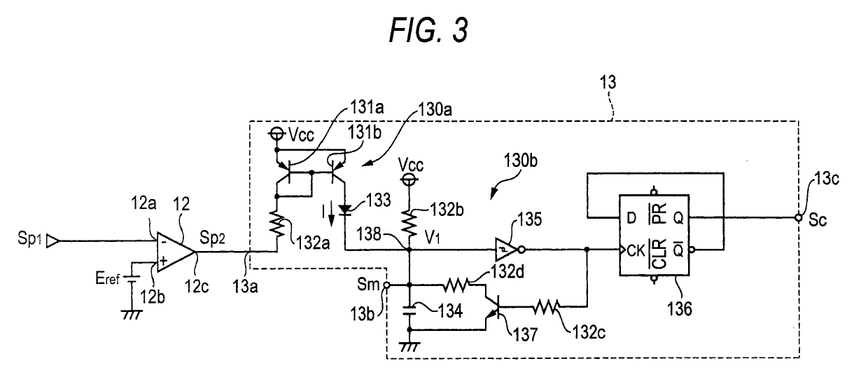

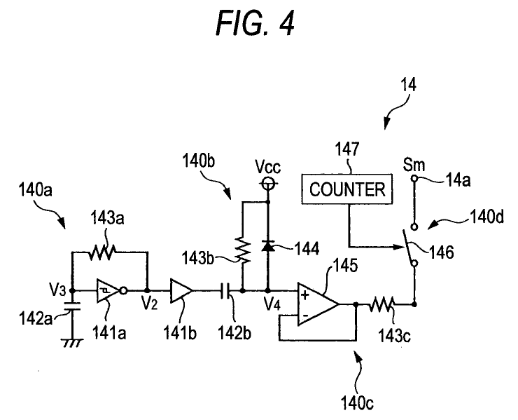

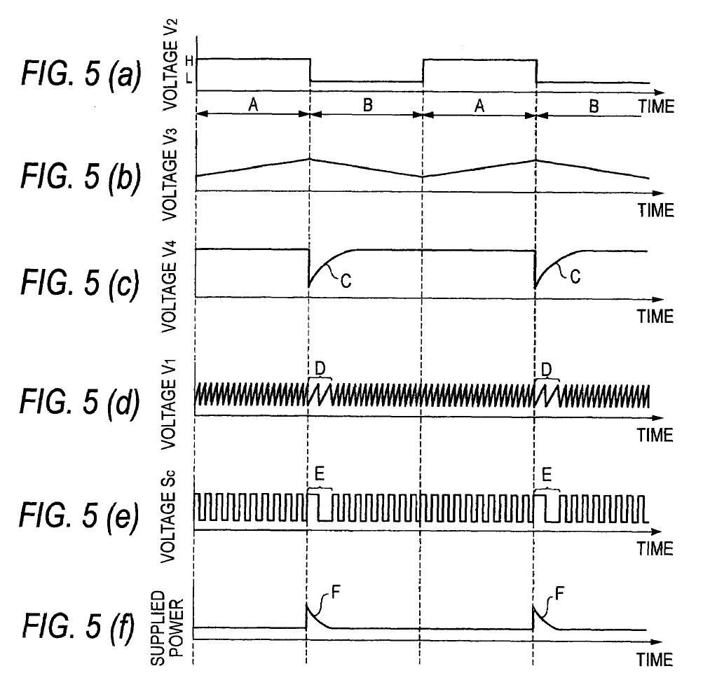

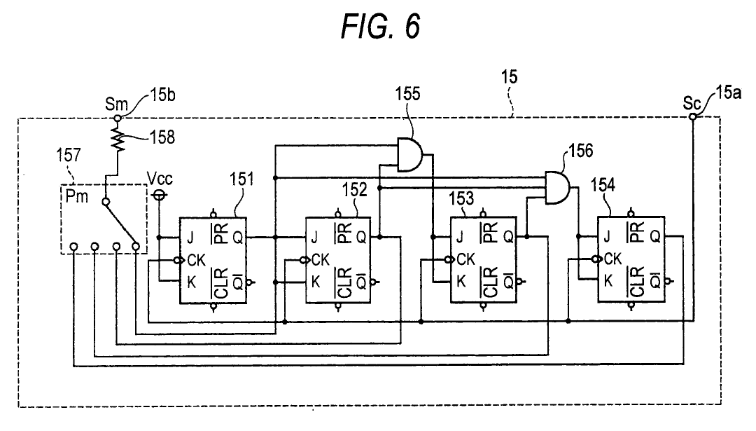

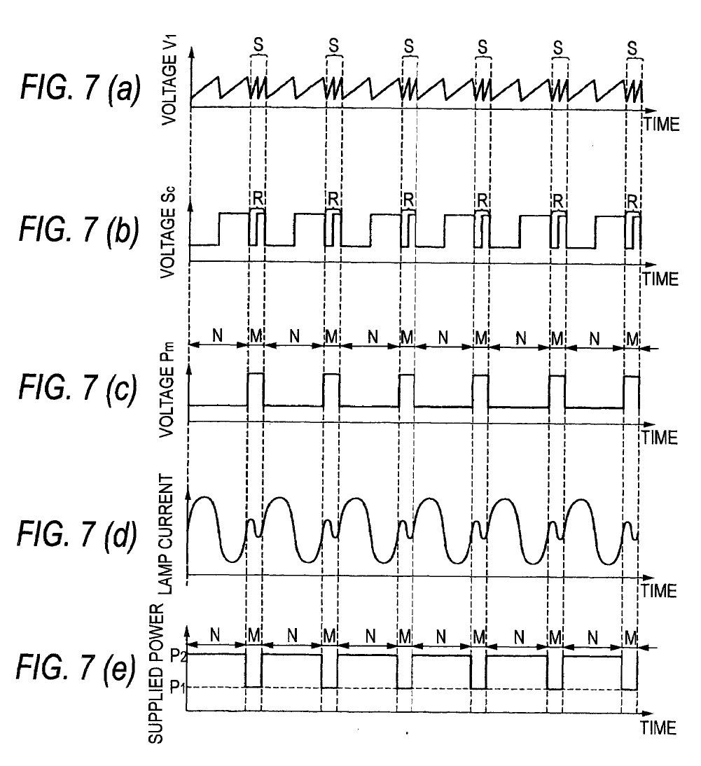

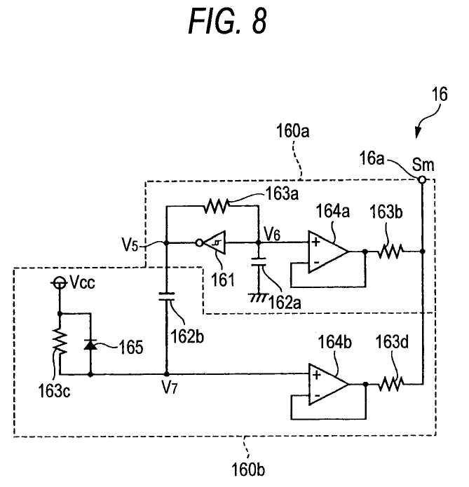

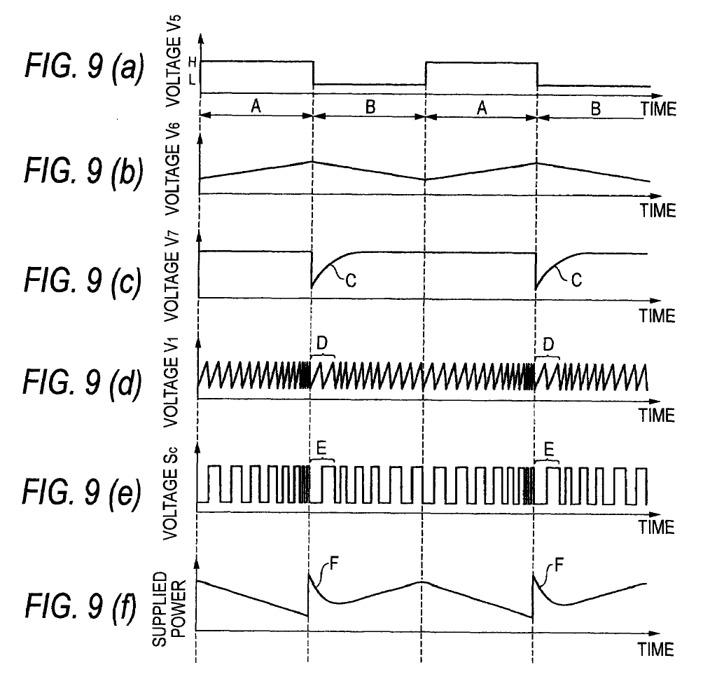

### BRIEF DESCRIPTION OF THE DRAWINGS

[FIG. 1] A block diagram showing the configuration of an embodiment of the discharge lamp lighting circuit according to the invention.

[FIG. 2] A graph schematically showing a relation between the driving frequency and the power supplied to the transistors.

[FIG. 3] A circuit diagram showing an example of the concrete configuration of an error amplifier and a V-F conversion portion.

[FIG. 4] A circuit diagram showing an example of the concrete configuration of a frequency modulation portion.

[FIG. 5] Graphs showing one examples of the waveforms of the main signals of a V-F conversion portion and a frequency modulation portion, in which (a) shows the waveform of the output voltage of a comparator of the frequency modulation portion, (b) shows the waveform of a voltage between both the terminals of the capacitor of the frequency modulation portion, (c) shows the waveform of an input voltage to s buffer amplifier, (d) shows the waveform of a voltage at the coupling point of the V-F conversion portion, (e) shows the waveform of the Q output of the D flip flop in the V-F conversion portion, and (f) shows a graph showing an example of the temporal change of the magnitude of the power supplied to the discharge lamp.

[FIG. 6] A circuit diagram showing the configuration of a frequency modulating portion as a first modified example.

[FIG. 7] Graphs showing one examples of the waveforms of the main signals of the V-F conversion portion and the frequency modulating portion of the first modified example, in which (a) shows the waveform of a voltage at the coupling point of the V-F conversion portion, (b) shows the waveform of the Q output of a D flip flop in the V-F conversion portion, (c) shows the waveform of a modulation signal outputted from a switch, (d) is a graph showing the waveform of a current of the discharge lamp, and (e) is a graph showing the temporal change of the magnitude of the power supplied to the discharge lamp.

[FIG. 8] A circuit diagram showing the configuration of a frequency modulating portion as a second modified example.

[FIG. 9] Graphs showing one examples of the waveforms of the main signals of the V-F conversion portion and the frequency modulating portion of the second modified example, in which (a) shows the waveform of the output voltage of the comparator of the frequency modulating portion, (b) shows the waveform of a voltage between both the terminals of the capacitor of the frequency modulating portion, (c) shows the waveform of an input voltage to a buffer amplifier, (d) shows the waveform of the voltage at the coupling point of the V-F conversion portion, (e) shows the waveform of the Q output of the D flip flop 136 in the V-F conversion portion, and (f) shows a graph showing an example of the temporal change of the magnitude of the power supplied to the discharge lamp.

[FIG. 10] A sectional diagram schematically showing a state within the tube of a discharge lamp being lighted.

[FIG. 11](a) is a graph showing an example of a lamp current waveform in a case where a lamp current formed by a rectangular waveform of a relatively low frequency is supplied to a discharge lamp and (b) is a graph showing an example of a temperature change of electrodes corresponding to (a).

[FIG. 12](a) is a graph showing an example of a lamp current waveform in a case where an AC current of a relatively high frequency is supplied to a discharge lamp and (b) is a graph showing an example of a temperature change of the electrodes corresponding to (a)

### BEST MODE FOR CARRYING OUT THE INVENTION

In the following paragraphs, an explanation will be made in detail as to an example of a preferred implementation t of a discharge lamp lighting circuit according to the invention with reference to drawings.

FIG. 1 is a block diagram showing the configuration of an example of the discharge lamp lighting circuit according to the invention. The discharge lamp lighting circuit 1 shown in FIG. 1 is a circuit for supplying an electric power for lighting a discharge lamp (L) to the discharge lamp and is arranged to convert a DC current from a DC power supply (Ba) such as a battery into an AC voltage to supply the DC voltage to the discharge lamp. The discharge lamp lighting circuit 1 is used for a lamp such as a headlamp in a vehicle. Although, as the discharge lamp (L), a metal halide lamp of mercury free is used preferably, a discharge lamp having another configuration may be used.

The discharge lamp lighting circuit 1 includes a power supply portion 2 which is supplied with a power from the DC power supply (Ba) and supplies an AC power to the discharge lamp (L) and a control portion 10 which controls the magnitude of a power supplied to the discharge lamp based on a voltage (hereinafter called as a lamp voltage) VL between electrodes of the discharge lamp.

The power supply portion 2 supplies a power having a magnitude based on a control signal (Sc) from the control portion 10 to the discharge lamp (L). The power supply portion 2 is coupled to the DC power supply (Ba) via a switch 20 for performing a lighting operation. The power supply portion is supplied with a DC voltage VB from the DC power supply (Ba) to convert the voltage into an AC voltage and boost the AC voltage.

The power supply portion 2 includes two transistors 5a and 5b as switching elements and a bridge driver 6 as a driving portion for driving these transistors 5a and 5b. Further, the power supply portion 2 includes a transformer 7, a capacitor 8 and an inductance 9. The transistors 5a, 5b, transformer 7, capacitor 8 and inductor 9 constitute a series resonance circuit.

As each of the transistors 5a, 5b, N-channel MOSFET is preferably used as shown in FIG. 1, for example, but another type of FET or a bipolar transistor may be used. In this embodiment, the drain terminal of the transistor 5a is coupled to the positive electrode side terminal of the DC power supply (Ba), the source terminal of the transistor 5a is coupled to the drain terminal of the transistor 5b, and the gate terminal of the transistor 5a is coupled to the bridge driver 6. The source terminal of the transistor 5b is coupled to a ground voltage line GND (that is, the negative electrode side terminal of the DC power supply (Ba)), and the gate terminal of the transistor 5b is coupled to the bridge driver 6. The bridge driver 6 alternately turns on the transistors 5a, 5b.

The transformer 7 supplies a high-voltage pulse and a power to the discharge lamp (L) and boosts the lamp voltage (VL). The primary winding 7a of the transformer 7, the inductor 9 and the capacitance 8 are coupled in series. The one end of this series circuit is coupled to the source terminal of the transistor 5a and the drain terminal of the transistor 5b, and the other end thereof is coupled to the ground voltage line GND. In this configuration, a resonance frequency is determined by the capacitance of the capacitor 8 and a composite reactance which is formed by the leakage inductance of the primary winding 7a of the transformer 7 and the inductance of the inductor 9. In place of such the configuration, the inductor 9 may be eliminated and the series resonance circuit may be configured by the primary winding 7a and the capacitor 8. Further, alternatively, the inductance of the primary winding 7a may be set to be small as compared with that of the inductor 9 so that the resonance frequency is determined primarily by the inductance of the primary winding 7a and the capacitance of the capacitor 8.

In the power supply portion 2, the driving frequency of the transistors 5a, 5b is set to a value equal to or higher than the series resonance frequency by using the series resonance phenomenon of the capacitor 8 and the inductive elements (the inductance component and the inductor) to alternately turn on/off the transistors 5a, 5b, whereby an AC power is generated at the primary winding 7a of the transformer 7. The AC power is boosted on the secondary winding 7b of the transformer 7 and supplied to the discharge lamp (L) coupled to the secondary winding 7b. The bridge driver 6 for driving the transistors 5a, 5b drives the transistors 5a, 5b in an opposite manner so that both the transistors 5a, 5b are placed in coupled states simultaneously.

The impedance of the series resonance circuit changes by the driving frequency applied to the transistors 5a, 5b from the bridge driver 6. Thus, the magnitude of AC power supplied to the discharge lamp (L) can be controlled by changing the driving frequency. FIG. 2 is a graph schematically showing a relation between the driving frequency and the power supplied to the transistors 5a, 5b. As shown in FIG. 2, the power supplied to the discharge lamp (L) becomes maximum (Pmax) when the driving frequency is same as the series resonance frequency (fo) and decreases as the driving frequency becomes larger (or smaller) than the series resonance frequency (fo). In this respect, when the driving frequency is smaller than the series resonance frequency (fo), a switching loss becomes larger and so a power efficiency degrades. Thus, the driving frequency of the bridge driver 6 is controlled so as to be in a range (a range X in the figure) larger than the series resonance frequency (fo). In this embodiment, the driving frequency of the bridge driver 6 is controlled in accordance with a pulse frequency of a control signal (Sc) (a signal including a frequency-modulated pulse sequence) from the control portion 10 coupled to the bridge driver 6.

Further, the power supply portion 2 according to the illustrated embodiment further includes a start circuit 3 for applying a starting high-voltage pulse to the discharge lamp (L) at the time of staring lighting. That is, when a trigger voltage and current is supplied to the transformer 7 from the start circuit 3, the high-voltage pulse is superimposed on the AC voltage generated at the secondary winding 7b of the transformer 7. The start circuit 3 of the embodiment is arranged in a manner that one of the output terminals thereof is coupled on the way of the primary winding 7a of the transformer 7 and the other of the output terminals thereof is coupled to the ground voltage side terminal of the primary winding 7a. The input voltage to the start circuit 3 may be obtained from the secondary winding 7b or a staring auxiliary winding (not shown) of the transformer 7, or obtained from another auxiliary winding which is provided so as to constitute the transformer 7 together with the inductor 9.

The control portion 10 controls the magnitude of the power supplied to the discharge lamp (L) based on the lamp voltage (VL) of the discharge lamp. The control portion 10 according to the embodiment includes a power calculation portion 11 for calculating the magnitude of the power to be supplied to the discharge lamp (L), an error amplifier 12 for amplifying a difference between an output voltage (SP1) from the power calculation portion 11 and a predetermined reference voltage and outputting the amplified difference, a V-F conversion portion 13 for subjecting an output voltage (SP2) from the error amplifier 12 to a voltage-frequency conversion (V-F conversion) to generate the control signal (Sc), and a frequency modulation portion 14 for modulating the control signal (Sc) so that the supplied power increases intermittently.

The power calculation portion 11 includes input terminals 11a, 11b and an output terminal 11c. The input terminal 11a is coupled to the intermediate tap of the secondary winding 7b via a peak hold circuit 21 in order to input a signal (hereinafter referred to as a “lamp voltage corresponding signal”) “VS”, representing the magnitude of the lamp voltage (VL) of the discharge lamp (L). The lamp voltage corresponding signal (VS) is set to 0.35 times, for example, as large as the peak value of the lamp voltage (VL). The input terminal 11b is coupled to the one end of a resistance element 4 provided in order to detect the lamp current of the discharge lamp (L) via a peak hold circuit 22 and a buffer 23. The one end of the resistance element 4 is further coupled to the one electrode of the discharge lamp (L) via the output terminal of the discharge lamp lighting circuit 1. The other end of the resistance element 4 is coupled to the ground voltage line GND. The buffer 23 outputs a lamp current corresponding signal (IS) representing the magnitude of the lamp current.

The power calculation portion 11 calculates the magnitude of the supply power necessary for the discharge lamp (L) based on the lamp voltage corresponding signal (VS) and the lamp current corresponding signal (IS) and generates the output voltage (SP1) representing the magnitude of the supply power. The output terminal 11c of the power calculation portion 11 is coupled to the input terminal of the error amplifier 12 and so the output voltage (SP1) is inputted to the error amplifier 12. The error amplifier 12 outputs the difference between the output voltage (SP1) and the predetermined reference voltage as the output voltage (SP2).

The V-F conversion portion 13 includes input terminals 13a, 13b and an output terminal 13c. The input terminal 13a is coupled to the output terminal of the error amplifier 12 in order to input the output voltage (SP2). Further, the input terminal 13b is coupled to the frequency modulation portion 14. The frequency modulation portion 14 outputs a modulation control signal (Sm) for modulating the control signal (Sc). The frequency modulation portion 14 according to the embodiment modulates the control signal (Sc) in a manner that the AC power supplied to the discharge lamp (L) increases in an impulse manner with a certain period. The output terminal 13c is coupled to the bridge driver 6. The V-F conversion portion 13 conducts the V-F conversion as to the output voltage (SP2) from the error amplifier 12 and supplies the voltage thus converted to the bridge driver 6 as the control signal (Sc).

The explanation will be made as to the entire operation of the discharge lamp lighting circuit 1 having the foregoing configuration. First, while the bridge driver 6 drives the transistors 5a, 5b with the predetermined driving frequency, the start circuit 3 applies the high-voltage pulses of several tens kV between the electrodes of the discharge lamp (L) to urge the dielectric breakdown. Immediately thereafter, the control portion 10 controls the driving frequency from the bridge driver 6 to a value for attaining the predetermined maximum power (75 W at the time of a cold start). Thereafter, the control portion 10 controls the driving frequency from the bridge driver 6 gradually to a value for attaining a normal or steady power (for example, 35 W). In the control portion 10, the power calculation portion 11 performs the calculation for controlling the driving frequency in this manner. The output voltage (SP2) from the error amplifier 12 representing the difference between the output voltage (SP1) from the power calculation portion 11 and the predetermined reference voltage is subjected to the V-F conversion in the V-F conversion portion 13 and the voltage thus converted is supplied to the bridge driver 6 as the control signal (Sc).

The explanation will be made as to an example of the concrete configuration of the control portion 10. FIG. 3 is a circuit diagram showing an example of the concrete configuration of the error amplifier 12 and the V-F conversion portion 13.

In FIG. 3, the inverting input terminal 12a of the error amplifier 12 is supplied with the output voltage (SP1) from the power calculation portion 11 and the non-inverting input terminal 12b thereof is supplied with a predetermined reference voltage (Eref). The output terminal 12c of the error amplifier 12 is coupled to the input terminal 13a of the V-F conversion portion 13. The input terminal 13a is supplied with the output voltage (SP2) from the error amplifier 12.

The V-F conversion portion 13 includes a current mirror circuit 130a and a ramp wave generating portion 130b. The current mirror circuit 130a is configured by a pair of PNP transistors 131a, 131b. That is, the emitter of each of the transistors 131a, 131b is coupled to a constant voltage supply (Vcc) and the bases of the transistors 131a, 131b are coupled to each other. The collector of the transistor 131a is coupled to the base thereof and also coupled to the input terminal 13a of the V-F conversion portion 13 via a resistance element 132a. The collector of the transistor 131b is coupled to the anode of a diode 133 and the cathode of the diode 133 is coupled to a coupling point 138 of the ramp wave generating portion 130b.

The ramp wave generating portion 130b includes resistance elements 132b to 132d, a capacitor 134, a comparator 135 with a hysteresis property and an NPN transistor 137. The one end of the resistance element 132b and the one end of the capacitor 134 are coupled to each other via the coupling point 138. The other end of the resistance element 132b is coupled to the constant voltage supply (Vcc) and the other end of the capacitor 134 is coupled to the ground voltage. The coupling point 138 is coupled to the input terminal of the comparator 135 and the output terminal of the comparator 135 is coupled to the base of the transistor 137 via the resistance element 132c. The collector of the transistor 137 is coupled to the coupling point 138 via the resistance element 132d. The emitter of the transistor 137 is coupled to the ground voltage. The coupling point 138 is coupled to the input terminal 13b of the V-F conversion portion 13 and so receives the modulation control signal (Sm) from the frequency modulation portion 14.

The V-F conversion portion 13 further includes a D-type flip flop 136. The D-type flip flop 136 constitutes a T (toggle) type flip-flop since the D terminal thereof is coupled to the Q negation terminal (also called the “Q bar” terminal) thereof. The clock input terminal (CK) of the D flip flop 136 is coupled to the output terminal of the comparator 135, whereby the clock input terminal (CK) of the D-type flip flop 136 is supplied with an output signal from the comparator 135. The Q output terminal of the D-type flip flop 136 is coupled to the output terminal 13c of the potion 13, whereby the output signal from the Q output terminal is supplied to the bridge driver 6 (FIG. 1) as the control signal (Sc).

In the V-F conversion portion 13, since a current (I) from the current mirror circuit 130a is charged in the capacitor 134, a voltage (V1) between both the terminals of the capacitor 134 increases gradually. When the voltage (V1) between both the terminals of the capacitor 134 reaches a certain first threshold voltage, the output of the comparator 135 exhibits a H (high) level to turn on the transistor 137 thereby to discharge the capacitor 134. Due to the discharge, when the voltage (V1) between both the terminals of the capacitor 134 reduces to a second threshold voltage which is smaller than the first threshold voltage, the output of the comparator 135 exhibits a L (low level to turn off the transistor 137 thereby to start the charging operation of the capacitor 134 again. The charging and discharging operations of the capacitor 134 are repeated alternately in this manner, whereby the voltage (V1) between both the terminals of the capacitor 134 (that is, the voltage at the coupling point 138) exhibits a ramp waveform (a PEM ramp waveform). The ramp waveform is changed in a rectangular waveform having a duty cycle of 50%, for example, when the ramp waveform passes through the comparator 135 and the D-type flip flop 136, whereby the rectangular waveform is outputted to the bridge driver 6 (FIG. 1) as the control signal (Sc).

Since the charging time of the capacitor 134 is determined in accordance with the magnitude of the current (I), the frequency of the ramp waveform (that is, the frequency of the control signal (Sc)) is a value according to the magnitude of the current (I). Further, the current (I) becomes smaller as the output voltage (SP2) from the error amplifier 12 becomes larger. In other words, the V-F conversion portion 13 has characteristics that the frequency of the control signal (Sc) becomes lower as the value of the output voltage (SP2) from the error amplifier 12 becomes larger. Thus, in the case of increasing the power supplied to the discharge lamp (L), the output voltage (SP2) is increased so that the frequency of the control signal (Sc) becomes lower in the frequency range (the range X) higher than the series resonance frequency (fo) (see FIG. 2) of the power supply portion 2.

FIG. 4 is a circuit diagram showing an example of the concrete configuration of the frequency modulation portion 14. Referring to FIG. 4, the frequency modulation portion 14 according to the embodiment includes a clock generating portion 140a, a differentiating circuit portion 140b, a buffer portion 140c and a start timing control portion 140d.

The clock generating portion 140a includes a comparator 141a with a hysteresis property, a capacitor 142a and a resistance element 143a. The input terminal of the comparator 141a is coupled to a coupling portion between the one end of the capacitor 142a and the one end of the resistance element 143a. The other end of the capacitor 142a is coupled to the ground voltage. The other end of the resistance element 143a is coupled to the output terminal of the comparator 141a.

The differentiating circuit portion 140b includes a capacitor 142b, a resistance element 143b and a diode 144. The one end of the capacitor 142b is coupled to the output terminal of the comparator 141a via a buffer 141b and the other end of capacitor is coupled to the constant voltage supply (Vcc) via the resistance element 143b. The anode of the diode 144 is coupled to the other end of the capacitor 142b and the cathode thereof is coupled to the constant voltage supply (Vcc).

The buffer portion 140c includes a buffer amplifier 145 and a resistance element 143c. The start timing control portion 140d includes a switching element 146 and a counter 147. The non-inverting input terminal of the buffer amplifier 145 is coupled to the other end of the capacitor 142b. The output terminal of the buffer amplifier 145 is coupled to the output terminal 14a of the frequency modulation portion 14 via the resistance element 143c and the switching element 146. An FET or a bipolar transistor, for example, is preferably used as the switching element 146. The control terminal (a gate terminal or a base terminal, for example) of the switching element 146 is coupled to the counter 147. The counter 147 counts a elapsed time after the start of the lighting of the discharge lamp (L) and makes the both ends of the switching element 146 conductive upon the lapse of a predetermined time (for example, one second). The output terminal 14a is coupled to the input terminal 13b of the V-F conversion portion 13.

FIG. 5(a) to (e) are graphs showing examples of the waveforms of the main signals of the V-F conversion portion 13 and the frequency modulation portion 14. FIG. 5(a) shows the waveform of the output voltage (V2) of the comparator 141a of the frequency modulation portion 14. FIG. 5(b) shows the waveform of the voltage V3 between both the terminals of the capacitor 142a of the frequency modulation portion 14. FIG. 5(c) shows the waveform of the voltage on the other end side of the capacitor 142b (that is, an input voltage (V4) to the buffer amplifier 145). FIG. 5(d) shows the waveform of the voltage (V1) at the coupling point 138 of the V-F conversion portion 13 (see FIG. 3). FIG. 5(e) shows the waveform of the Q output (that is, the waveform of the control signal (Sc)) of the D-type flip flop 136 in the V-F conversion portion 13. FIG. 5(f) shows a graph showing an example of the temporal change of the magnitude of the power supplied to the discharge lamp (L) corresponding to FIGS. 5(a) to (e).

In the clock generating portion 140a (FIG. 4) of the frequency modulation portion 14, when the voltage (V3) between both the terminals of the capacitor 142a is low, since the output voltage (V2) of the comparator 141a exhibits the H level (a period A in FIG. 5(a)), the capacitor 142a is charged via the resistance element 143a, whereby the voltage (V3) between both the terminals of the capacitor 142a increases gradually (FIG. 5(b)). When the voltage (V3) between both the terminals of the capacitor 142a increases above a certain voltage, since the output voltage (V2) of the comparator 141a exhibits the L level (a period B in FIG. 5(a)), the capacitor 142a is discharged, whereby the voltage (V3) between both the terminals of the capacitor 142a decreases gradually (FIG. 5(b)). In this manner, the output voltage (V2) of the comparator 141a (FIG. 5(a)) alternately repeats the H and L levels at a certain constant period.

As shown in FIG. 5(c), in the differentiating circuit portion 140b, a voltage (V4) including a voltage waveform (C) of a periodical impulse shape is generated on the other end side of the capacitor 142b in correspondence to the rising edge of the output voltage (V2) (FIG. 5(a)) from the comparator 141a. When the switching element 146 (FIG. 34) is in a conductive state, the voltage (V4) is outputted to the V-F conversion portion 13 as the modulation control signal (Sm) via the buffer amplifier 145 and the resistance element 143c.

In the V-F conversion portion 13 (see FIG. 3), as described above, the voltage (V1) between both the terminals of the capacitor 134 (that is, the voltage at the coupling point 138) exhibits the ramp waveform as shown in FIG. 5(d). The ramp waveform is changed in the rectangular waveform as shown in FIG. 5(e) when the ramp waveform passes through the comparator 135 and the D-type flip flop 136, whereby the rectangular waveform is outputted to the bridge driver 6 (FIG. 1) as the control signal (Sc).

When the impulse-shaped voltage waveform C shown in FIG. 5(c) is inputted to the input terminal 13b of the V-F conversion portion 13 via the resistance element 143c as the modulation control signal (Sm), since the current flows into the buffer amplifier 145 of the frequency modulation portion 14 from the coupling point 138 of the V-F conversion portion 13, the charging time of the capacitor 134 becomes longer temporarily. Thus, the frequency of the ramp waveform reduces temporarily (a waveform D in FIG. 5(d)), and so the frequency of the control signal (Sc) also reduces temporarily (a waveform E in FIG. 5(e)). As a result, since the bridge driver 6 operates so that the frequency of the AC power supplied to the discharge lamp (L) reduces, the power supplied to the discharge lamp increases in an impulse manner (a waveform F of FIG. 5(f)). Such the increase of the supplied power is repeated intermittently each time the output voltage waveform (FIG. 5(a)) from the clock generating portion 140a falls.

The frequency modulation portion 14 generates the modulation control signal (Sm) so that the repetition frequency of the impulse-shaped voltage waveform C (FIG. 5(c)) contained in the modulation control signal (Sm) becomes lower than the frequency of the ramp waveform (FIG. 5(d)). Further, in the frequency modulation portion 14, the both end terminals of the switching element 146 are made conductive after the counter 147 counts the predetermined time (for example, one second) after the start of the lighting of the discharge lamp (L). Thus, the intermittent increase of the AC power is started as shown in FIG. 5(f) upon the lapse of the predetermined time after the start of the lighting of the discharge lamp (L).

The effects that result in some implementations of the discharge lamp lighting circuit 1 according to the embodiment as described above will be explained. The problem described above (i.e., the movement of a luminous point at the time of lighting the discharge lamp (L) with a high frequency) is caused by the insufficient increase of the temperature of the electrodes at the time of switching the polarity. In the discharge lamp lighting circuit 1 according to the embodiment, as shown in FIG. 5(f), for example, the control portion 10 (particularly, the V-F conversion portion 13 and the frequency modulation portion 14) controls the bridge driver 6 so at the AC power supplied to the discharge lamp (L) increases intermittently. Thus, the temperature of the electrodes can be increased while suppressing the temporal average value of the supplied power to a value near the rated power of the discharge lamp L (for example, the steady power 35 W). Thus, according to the discharge lamp lighting circuit 1 of the embodiment, the movement of a luminous point at the time of lighting the discharge lamp (L) with a high frequency can be effectively suppressed.

Like this embodiment, preferably, the control portion 10 controls the bridge driver 6 so that the AC power supplied to the discharge lamp (L) increases in the impulse manner like the waveform F shown in FIG. 5(f), for example. Thus, the temperature of the electrodes can be increased while suitably suppressing the temporal average value of the supplied power.

Like this embodiment, preferably, the control portion 10 (particularly, the frequency modulation portion 14) starts the intermittent increase of the AC power upon the lapse of the predetermined time after the start of the lighting of the discharge lamp (L). In general, since the arc discharge between the electrodes is unstable immediately after the lighting of the discharge lamp (L), in most cases, the starting performance of the discharge lamp is secured by supplying to the discharge lamp the maximum power within the power supply ability of the discharge lamp lighting circuit. In this case, when the supplied power is changed intermittently, there arises a case that the discharge lamp (L) is turned off since there appears a time period during which the supplied power becomes smaller than the maximum power. In contrast, like the discharge lamp lighting circuit 1 of the embodiment, when the intermittent increase of the supplied power is started upon the lapse of the predetermined time after the start of the lighting of the discharge lamp (L), not only the starting performance of the discharge lamp can be secured but also the movement of luminous point can be suppressed, preferably.

FIG. 6 is a circuit diagram showing the configuration of a frequency modulating portion 15 as a first modified example of the aforesaid embodiment. The frequency modulating portion 15 is provided in place of the frequency modulation portion 14 of the aforesaid embodiment.

The frequency modulating portion 15 is a circuit which outputs the modulation control signal Sm for modulating the control signal (Sc) to the V-F conversion portion 13 (see FIGS. 1 and 3). Unlike the frequency modulation portion 14 of the aforesaid embodiment, the frequency modulating portion 15 of this modified example modulates the control signal (Sc) in a manner that the magnitude of the AC power becomes a first power value in a first time region repeated periodically and becomes a second power value larger than the first power value in a second time region other than the first time region.

Referring to FIG. 6, the frequency modulating portion 15 of this modified example includes an input terminal 15a and an output terminal 15b. The input terminal 15a is coupled to the output terminal 13c (see FIG. 3) of the V-F conversion portion 13 of the aforesaid embodiment and the input terminal 15a receives the control signal (Sc). The output terminal 15b is coupled to the input terminal 13b (see FIG. 3) of the V-F conversion portion 13 and the output terminal 15b outputs the modulation control signal (Sm).

The frequency modulating portion 15 is configured by a plurality of JK-type flip flops 151 to 154 and a counter circuit including a logical product (AND) circuits 155, 156. Specifically, the J terminal and the K terminal of the JK-type flip flop 151 of the first stage are coupled to the constant voltage supply (Vcc) and the Q terminal thereof is coupled to the J terminal and the K terminal of the JK-type flip flop 152 of the second stage. The Q terminals of the JK-type flip flops 151, 152 are coupled to the input terminals of the AND circuit 155, respectively, and the output terminal of the AND circuit 155 is coupled to the J terminal and the K terminal of the JK-type flip flop 153 of the third stage. The Q terminals of the JK-type flip flops 151 to 153 are coupled to the input terminals of the AND circuit 156 and the output of the AND circuit 156 is coupled to the J terminal and the K terminal of the JK-type flip flop 154 of the fourth stage. One of the Q terminals of the JK-type flip flops 151 to 154 is selected by a switch 157 and is coupled to the output terminal 15b of the frequency modulating portion 15 via a resistance element 158. The clock terminal of each of the JK-type flip flops 151 to 154 is applied with the control signal (Sc) which is inputted from the input terminal 15a.

FIG. 7(a) to (e) are graphs showing one examples of the waveforms of the main signals of the V-F conversion portion 13 and the frequency modulating portion 15 of this modified example. FIG. 7(a) shows the waveform of the voltage (V1) at the coupling point 138 of the V-F conversion portion 13 (see FIG. 3). FIG. 7(b) shows the waveform of the Q output (that is, the waveform of the control signal Sc) of the D flip flop 136 in the V-F conversion portion 13. FIG. 7(c) shows the waveform of a modulation signal Pm outputted from the switch 157. FIG. 7(d) is a graph showing the waveform of the lamp current of the discharge lamp (L) corresponding to FIGS. 7(a) to (c), and FIG. 7(e) is a graph showing the temporal change of the magnitude of the power supplied to the discharge lamp L corresponding to FIGS. 7(a) to (c). FIG. 7(a) to (e) shows as one example the waveforms in the case where the switch 157 selects the Q output terminal of the JK-type flip flop 151 of the first stage.

In the V-F conversion portion 13 (see FIG. 3), the voltage (V1) (that is, the voltage of the coupling point 138) between both the terminals of the capacitor 134 exhibits a ramp waveform as shown in FIG. 7(a). The ramp waveform is changed in a rectangular waveform as shown in FIG. 7(b) when the ramp waveform passes through the comparator 135 and the D-type flip flop 136, whereby the rectangular waveform is outputted to the bridge driver 6 (FIG. 1) as the control signal (Sc).

On the other hand, when the control signal (Sc) is inputted to the clock terminals of the JK-type flip flops 151 to 154, the output levels of the Q terminals of the JK-type flip flops 151 to 154 change at every one, two, four and eight periods of the control signal (Sc), respectively. That is, the output level of each of the Q terminals of the JK-type flip flops 151 to 154 exhibits an H level in the first time region M repeated periodically and exhibits an L level in the second time region N other than the first time region M as shown in FIG. 7(c), for example (FIG. 7(c) exemplarily shows the output waveform of the Q terminal of the JK-type flip flop 151). The output (the modulation signal (Pm)) of the Q terminal of the JK-type flip flop selected by the switch 157 is changed in the ramp waveform by the actions of the resistance element 158 and the capacitor 134 (see FIG. 3) and the ramp waveform is inputted into the input terminal 13b of the V-F conversion portion 13 as the modulation control signal (Sm).

When the modulation control signal (Sm) is inputted into the input terminal 13b of the V-F conversion portion 13, the modulation control signal serves to increase the charging current supplied to the capacitor 134 of the V-F conversion portion 13 (see FIG. 3) when the modulation signal Pm shown in FIG. 7(c) exhibits the H level (that is, the first time region M) to increase the frequency of the ramp waveform (a waveform S of FIG. 7(a)). Thus, the frequency of the control signal (Sc) also increases (a waveform R of FIG. 7(b)). On the contrary, the modulation control signal serves to reduce the charging current supplied to the capacitor 134 when the modulation signal (Pm) shown exhibits the L level (that is, the second time region N) to reduce the frequency of the control signal (Sc). As a result, since the bridge driver 6 operates in a manner that the frequency of the lamp current (FIG. 7(d)) flowing into the discharge lamp (L) reduces intermittently, the power supplied to the discharge lamp increases intermittently as shown in FIG. 7(e). Specifically, the magnitude of the AC power exhibits a first power value (P1) in the first time region M repeated periodically and exhibits a second power value (P2) (where P2>P1) in the second time region N other than the first time region M.

In the frequency modulating portion 15, although the control signal (Sc) is used as the clock input to each of the JK-type flip flops 151 to 154, another clock signal having a frequency lower than that of the ramp waveform (FIG. 7(a)) may be used as the clock input to each of the JK-type flip flops 151 to 154 in place of the control signal. Further, the period of increasing the power (or the period of decreasing the power) supplied to the discharge lamp (L) can be set by selecting arbitrary one of the outputs of the Q terminals of the JK-type flip flops 151 to 154 in the switch 157. Further, preferably, the frequency modulating portion 15 further includes, between the resistance element 158 and the output terminal 15b, for example, a circuit similar to the switching element 146 and the counter 147 of the frequency modulation portion 14 of the aforesaid embodiment. As shown in FIG. 7(e), the intermittent increase of the AC power is preferably started upon the lapse of the predetermined time after the start of the lighting of the discharge lamp (L).

Since the discharge lamp lighting circuit includes the frequency modulating portion 15 of this modified example, the effects similar to those of the aforesaid embodiment can be attained. That is, in the frequency modulating portion 15 of this modified example, since the control signal (Sc) is modified so that the AC power supplied to the discharge lamp L increases intermittently as shown in FIG. 7(e), the temperature of the electrodes can be increased while suppressing the temporal average value of the supplied power to a value near the rated power of the discharge lamp (L). Thus, the movement of a luminous point at the time of lighting the discharge lamp (L) with a high frequency can be effectively suppressed.

Further, in this modified example, the bridge driver 6 is controlled so that the magnitude of the AC power exhibits the first power value (P1) in the first time region M repeated periodically and exhibits the second power value (P2) (where P2>P1) in the second time region N other than the first time region M. Thus, since the electrode temperature is increased sufficiently in the second time region N and the lighting state is kept in the first time region M by the so-called after growing, the movement of a luminous point can be suppressed more effectively.

FIG. 8 is a circuit diagram showing the configuration of a frequency modulating portion 16 as a second modified example of the aforesaid embodiment. The frequency modulating portion 16 is provided in place of the frequency modulation portion 14 of the aforesaid embodiment. The frequency modulating portion 16 of this modified example includes a continuous modulation portion 160a and an intermittent modulation portion 160b.

The continuous modulation portion 160a is a circuit which continuously increases and decreases the frequency of the AC power supplied to the discharge lamp (L) in order to prevent the acoustic resonance in the discharge lamp. The continuous modulation portion 160a of this modified example includes a comparator 161 with a hysteresis property, a capacitor 162a, resistance elements 163a and 163b, and a buffer amplifier 164a. The input terminal of the comparator 161 is coupled to a coupling point between the one end of the capacitor 162a and the one end of the resistance element 163a. The other end of the capacitor 162a is coupled to the grounding voltage. The other end of the resistance element 163a is coupled to the output terminal of the comparator 161.

The non-inverting input terminal of the buffer amplifier 164a is coupled to the one end of the capacitor 162a. The output terminal of the buffer amplifier 164a is coupled to the output terminal 16a of the frequency modulating portion 16 via the resistance element 163b. The output terminal 16a is coupled to the input terminal 13b of the V-F conversion portion 13 shown in FIG. 3.

The intermittent modulation portion 160b is a circuit which intermittently increases the AC power supplied to the discharge lamp (L) in order to suppress the movement of a luminous point in the discharge lamp. The intermittent modulation portion 160b includes a capacitor 162b, resistance elements 163c and 163d, a buffer amplifier 164b and a diode 165. The one end of the capacitor 162b is coupled to the output terminal of the comparator 161 of the continuous modulation portion 160a and the other end thereof is coupled to the constant voltage supply (Vcc) via the resistance element 163c. The anode of the diode 165 is coupled to the other end of the capacitor 162b and the cathode thereof is coupled to the constant voltage supply Vcc.

The non-inverting input terminal of the buffer amplifier 164b is coupled to the one end of the capacitor 162b. The output terminal of the buffer amplifier 164b is coupled to the output terminal 16a of the frequency modulating portion 16 via the resistance element 163d.

FIG. 9(a) to (e) are graphs showing one examples of the waveforms of the main signals of the V-F conversion portion 13 (see FIG. 3) and the frequency modulating portion 16 of this modified example. FIG. 9(a) shows the waveform of the output voltage V5 of the comparator 161 of the frequency modulating portion 16. FIG. 9(b) shows the waveform of a voltage (V6) between both the terminals of the capacitor 162a of the frequency modulating portion 16. FIG. 9(c) shows the waveform of the voltage on the other end side of the capacitor 162b (that is, an input voltage (V7) to the buffer amplifier 164b). FIG. 9(d) shows the waveform of the voltage (V1) at the coupling point 138 of the V-F conversion portion 13 (see FIG. 3). FIG. 9(e) shows the waveform of the Q output (that is, the waveform of the control signal (Sc)) of the D-type flip flop 136 in the V-F conversion portion 13. FIG. 9(f) shows a graph showing an example of the temporal change of the magnitude of the power supplied to the discharge lamp (L) corresponding to FIGS. 9(a) to (e).

In the continuous modulation portion 160a of the frequency modulating portion 16, when the voltage (V6) between both the terminals of the capacitor 162a is low, since the output voltage V5 of the comparator 161a exhibits the H level (a period A in FIG. 9(a)), the capacitor 162a is charged via the resistance element 163a, whereby the voltage (V6) between both the terminals of the capacitor 162a increases gradually (FIG. 9(b)). When the voltage (V6) between both the terminals of the capacitor 162a increases above a certain voltage, since the output voltage (V5) of the comparator 161 exhibits the L level (a period B in FIG. 9(a)), the capacitor 162a is discharged, whereby the voltage (V6) between both the terminals of the capacitor 162a decreases gradually (FIG. 9(b)). In this manner, the voltage V6 (FIG. 9(b)) between both the terminals of the capacitor 162a increases and decreases continuously and repeatedly with a period constituted by the sum of the periods A and B. The voltage (V6) between both the terminals of the capacitor 162a is outputted to the V-F conversion portion 13 (see FIG. 3) as the modulation control signal (Sm) via the buffer amplifier 164a and the resistance element 163b.

Thus, the frequency of the voltage (V1) (ramp waveform) between both the terminals of the capacitor 134 of the V-F conversion portion 13 changes continuously as shown in FIG. 9(d). That is, the frequency of the ramp waveform increases gradually in the period A and decreases gradually in the period B. The ramp waveform is changed in the rectangular waveform as shown in FIG. 9(e) when the ramp waveform passes through the comparator 135 and the D-type flip flop 136, whereby the rectangular waveform is outputted to the bridge driver 6 (FIG. 1) as the control signal (Sc). As a result, since the bridge driver 6 operates so that the frequency of the AC power supplied to the discharge lamp (L) increases and decreases continuously and repeatedly, the frequency of the AC power supplied to the discharge lamp increases and decreases continuously and repeatedly with the period constituted by the sum of the periods A and B.

As shown in FIG. 9(a), in the continuous modulation portion 160a, the output voltage (V5) of the comparator 161 alternately exhibits the H and L levels with a certain constant period. On the other hand, in the intermittent modulation portion 160b, the output voltage waveform of the comparator 161 is differentiated by a differentiating circuit formed by the capacitor 162b, the resistance element 163c and the diode 165. That is, as shown in FIG. 9(c), a voltage waveform C of a periodical impulse shape is generated on the other end side of the capacitor 162b in correspondence to the falling edge of the output voltage (V5) from the comparator 161. The voltage (V7) on the other end side of the capacitor 162b is superimposed on the modulation control signal (Sm) via the buffer amplifier 164b and the resistance element 163d and then outputted to the V-F conversion portion 13 (see FIG. 3).

When the voltage waveform C of the impulse shape shown in FIG. 9(c) is inputted into the V-F conversion portion 13 as the modulation control signal (Sm) via the resistance element 163d, the frequency of the ramp waveform reduces temporarily (a waveform D of FIG. 9(d)), whereby the frequency of the control signal (Sc) also reduces temporarily (a waveform E of FIG. 9(e)). As a result, since the frequency of the AC power supplied to the discharge lamp (L) reduces intermittently, the AC power supplied to the discharge lamp increases in an impulse manner (a waveform F of FIG. 9(f)). Such the discontinuous increase of the supplied power is repeated each time the input voltage (V6) (FIG. 9(b)) of the comparator 161 becomes the maximum (that is, started at a timing where the power supplied to the discharge lamp (L) becomes minimum).

In this modified example, since the continuous modulation portion 160a controls the bridge driver 6 so that the frequency of the power supplied to the discharge lamp (L) increases and decreases continuously and repeatedly, the acoustic resonance in the discharge lamp can be suppressed effectively. Further, since the supplied power is increased discontinuously (the waveform F of FIG. 9(f)) from the timing where the power supplied to the discharge lamp (L) becomes the minimum, the electrode temperature can be increased at a timing where the electrode temperature becomes a lowest value, whereby the movement of a luminous point at the time of lighting the discharge lamp with a high frequency can be effectively suppressed.

When the frequency of the AC power supplied to the discharge lamp (L) is 1 MHz or more, the frequency is out of the continuous resonance band of the acoustic resonance, the generation probability of the continuous resonance can be reduced (but the generation probability of the continuous resonance does not become o since there is a higher harmonic component due to the tubular shape of the discharge lamp). Further, in the case where the discharge lamp (L) and the discharge lamp lighting circuit are used for a vehicle, the frequency of the AC power is desirably set so as to avoid the radio noise broadcasting band (the AM band of 500 kHz through 1,700 kHz or the SW band of 2.8 MHz through 23 MHz etc.). Thus, a frequency of about 2 MHz is suitable as the frequency of the AC power. However, the movement of a luminous point appears remarkably when the frequency is 1.5 MHz or more. Thus, there is no frequency region which can avoid all the acoustic resonance, the radio noise and the movement of a luminous point. According to the configuration of this modified example, both the acoustic resonance and the movement of a luminous point can be suppressed effectively. Thus, the frequency of the AC power can be set to an arbitrary frequency except for the radio noise broadcasting band.

The discharge lamp lighting circuit according to the invention is not limited to the foregoing respective embodiments and various modifications may be made. For example, although, in the aforesaid embodiments, the control signal is modulated intermittently by operating the internal signal of the V-F conversion portion (the voltage V1 between both the terminals of the capacitor 134), the control portion according to the invention may intermittently modulate the control signal by superimposing the voltage signal increasing intermittently on the voltage inputted into the V-F conversion portion.

Other implementations are within the scope of the claims.

1. A discharge lamp lighting circuit to supply an AC power to a discharge lamp for lighting the discharge lamp, the circuit comprising:
a power supply portion to supply the AC power to the discharge lamp; and
a control portion to control a magnitude of the AC power,
wherein the power supply portion includes a series resonance circuit having a plurality of switching elements, at least one of an inductance and a transformer and a capacitor, and a driving portion to drive the plurality of switching elements, and
wherein the control portion is operable to control the driving portion so that the AC power increases intermittently.

2. A discharge lamp lighting circuit according to claim 1, wherein the control portion is operable to control the driving portion so that the AC power increases in an impulse manner.

3. A discharge lamp lighting circuit according to claim 1, wherein the control portion is operable to control the driving portion so that a magnitude of the AC power becomes a first power value in a first time region repeated periodically and becomes a second power value larger than the first power value in a second time region other than the first time region.

4. A discharge lamp lighting circuit according to claim 1, wherein the control portion is operable to control the driving portion so that a frequency of the AC power increases and decreases continuously and repeatedly, and the AC power increases intermittently from a timing where the AC power becomes a minimum.

5. A discharge lamp lighting circuit according to claim 1, wherein the control portion is operable to start to increase the AC power intermittently upon lapse of a predetermined time after start of lighting of the discharge lamp.

6. A discharge lamp lighting circuit according to claim 4, wherein the control portion is operable to start to increase the AC power intermittently upon lapse of a predetermined time after start of lighting of the discharge lamp.
